(19) United States
(12) Patent Application Publication
(10) Pub. No.: US 2007/0223591 A1
(43) Pub. Date: Sep. 27, 2007

(54) Frame Deblocking in Video Processing Systems

(75) Inventor: Sandeep Doshi, Santa Clara, CA (US)

Correspondence Address: DEMONT & BREYER, LLC, 100 COMMONS WAY, HOLMDEL, NJ, 07733, US

(73) Assignee: Metta Technology, Inc., San Jose, CA (US)

(21) Appl. No.: 11/277,173

(22) Filed: Mar. 22, 2006

(51) Int. Cl. H04N 11/04; H04N 11/02

(52) U.S. Cl. 375/240.24; 375/240.25

(57) ABSTRACT

A method and an apparatus are disclosed that seek to mitigate resource utilization during the video deblocking process of a video frame. The disclosed techniques are based on the observation that as long as the standardized filter order is preserved for those individual pixels that are filtered twice, such as corner pixels, it is unnecessary to filter across the entire video frame, first across one dimension, then across another. The video deblocker of the illustrative embodiment of the present invention deblocks the video frame by considering the pixels to be filtered on a macroblock-by-macroblock basis. In some embodiments, the deblocker deblocks the macroblock by considering the pixels to be filtered on a sub-block-by-sub-block basis. The disclosed techniques are advantageous over some techniques in the prior art because the deblocker is only required to read in all of the macroblocks in a video frame once.

### FIELD OF THE INVENTION

The present invention relates to information technology in general, and, more particularly, to video decoding and filtering.

### BACKGROUND OF THE INVENTION

A source video stream can be encoded to decrease the amount of resources that are required to process the video frames in the stream. Various video compression standards, such as the VC-1 standard, the ITU-H.264 standard (H.264), and the MPEG-4 standard can be used to encode the picture elements, or “pixels,” contained in the frames. The encoding may comprise one or more of spatial prediction, temporal prediction, discrete cosine transformation, quantization, and entropy coding to compress multiple regions in each video frame that are referred to as “macroblocks.” As a consequence of the video encoding process, some of the original source information might be lost, particularly as a result of the quantization process.

In order to reconstruct the original video frames, such as for the purpose of displaying the frames, the encoded video stream is eventually decoded. FIG. 1 depicts the format of video frame 100 that comprises twenty macroblocks of decoded image data, referred to as macroblocks 101 through 120. Although not depicted, each macroblock can be further subdivided into regions that are referred to as “sub-blocks.” Also present are horizontal macroblock boundaries 131 through 133 and vertical macroblock boundaries 141 through 144. If none of the original pixels were lost in the course of the encoding and transmission, the boundaries between the macroblocks would not be noticeable and the image would appear seamless across the macroblock boundaries.

The quality of the decoded video signal, however, is typically impaired as a result of some loss of information, and artifacts consequently might appear. An effect known as “transform blockiness” might be present in the decoded video frames, in the form of square grid artifacts; this occurs as a result of information loss during the encoding process. In addition, effects other than transform blockiness might appear in the decoded video frames, as the result of information loss that occurs during the transmission between the encoder and the decoder. Transform blockiness might be associated with missing information along one or more horizontal or vertical boundaries between adjacent macroblocks or between adjacent sub-blocks within a macroblock. The blockiness often appears as harsh, unintended visual transitions between the macroblocks or sub-blocks.

In video systems utilizing blocks of video information, a video deblocker may be utilized to smooth the visual transition between adjacent video blocks. During the deblocking process in the prior art, macroblocks within a video frame are fetched, row-by-row, starting with the top row, and left-to-right within each row. The pixels that are near the boundaries of each sub-block in the video frame are then filtered (i.e., “deblocked”) in an order that is either (i) horizontal boundaries first, followed by vertical boundaries or (ii) vertical boundaries first, followed by horizontal boundaries, depending on the video standard in use. Typically, the order in which the horizontal boundaries are filtered is from top to bottom, and the order in which the vertical boundaries are filtered is from left to right.

### SUMMARY OF THE INVENTION

Depending on the video standard in use, the problem with the specified blocking order in some cases is that all of the boundaries across one dimension—for instance, all horizontal boundaries—must be filtered before the boundaries across the other dimension—for instance, the vertical boundaries—can be filtered. The order matters because some pixels (i.e., those in the corners of sub-blocks) are filtered twice and might be affected differently if the order were to be reversed. Deblocking across the entire video frame requires two memory read operations—the first for filtering across the first dimension, the second for filtering across the second dimension—which consumes memory and processing cycles.

The present invention seeks to mitigate resource utilization during the deblocking process and is based on the observation that as long as the standardized filter order is preserved for those individual pixels that are filtered twice, such as corner pixels, it is unnecessary to filter across the entire video frame, first across one dimension, then across another. The video deblocker of the illustrative embodiment of the present invention deblocks the video frame by considering the pixels to be filtered on a macroblock-by-macroblock basis. In some embodiments, the deblocker deblocks the macroblock by considering the pixels to be filtered on a sub-block-by-sub-block basis. To say that the video frame is deblocked on a block-by-block basis means that a row of pixels of a first block can be filtered after the column of a second block, even though the video frame is subject to rows-then-columns order of filtering. Likewise, a column of pixels of a first block can be filtered after the row of a second block, even though the video frame is subject to columns-then-rows order of filtering.

The deblocking that is performed in accordance with the illustrative embodiment reduces transform blockiness along the horizontal block boundaries and vertical block boundaries. The disclosed techniques are equally applicable to filtering along macroblock boundaries within a video frame and along sub-block boundaries within a macroblock. The techniques of the illustrative embodiment are advantageous over some techniques in the prior art because the deblocker is only required to read in all of the macroblocks in a video frame once, instead of having to read them in twice: once for the filtering across the first dimension (e.g., across rows, etc.) and once for the filtering across the second dimension (e.g., across columns, etc.).

The illustrative embodiment of the present invention comprises: deblocking the topmost row of block (x, y); deblocking the leftmost column of block (x, y) after deblocking the topmost row of block (x, y); and deblocking the bottommost row of block (x+a, y+b) after deblocking the leftmost column of block (x, y); wherein at least one of a and b is a positive integer, and wherein x and y are integers.

### BRIEF DESCRIPTION OF THE DRAWINGS

FIG. 1 depicts the format of video frame 100 in the prior art.

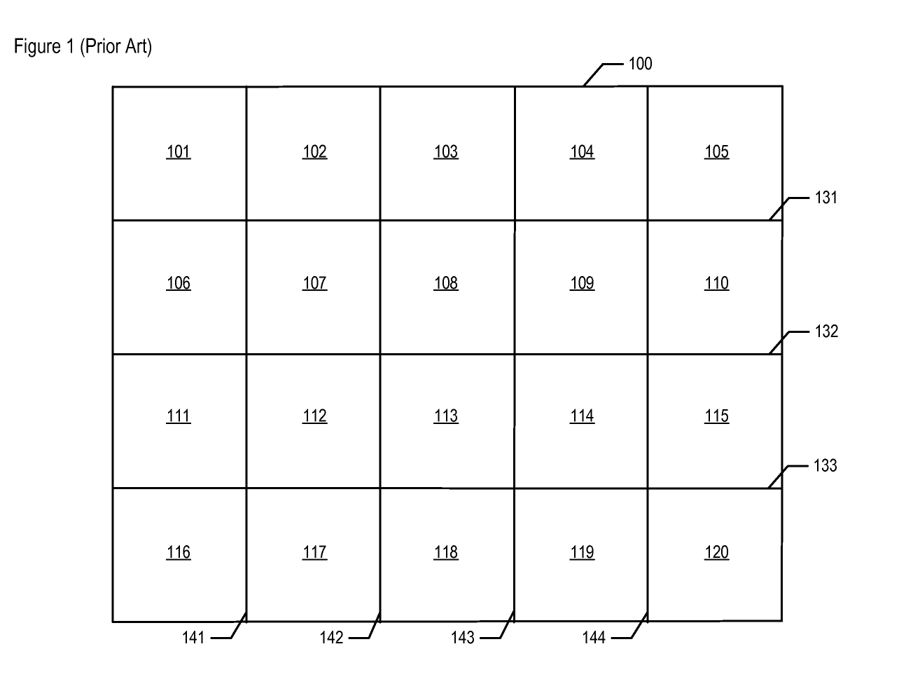

FIG. 2 depicts a block diagram of the salient components of deblocker 200 in accordance with the illustrative embodiment.

FIG. 3 depicts the format of video frame 300 in accordance with the illustrative embodiment of the present invention.

FIG. 4 depicts the format of video frame 400 in accordance with the illustrative embodiment of the present invention.

FIG. 5 depicts the format of video frame region 500 in accordance with the illustrative embodiment of the present invention.

FIG. 6 depicts a flowchart of the salient tasks associated with deblocking a video frame or macroblock that comprises block (x, y), in accordance with the illustrative embodiment of the present invention.

### DETAILED DESCRIPTION

The following terms are defined for use in this Specification, including the appended claims:
The term “pixel,” and its inflected forms, is a picture element, a spatio-temporal sample within the picture. A pixel has a “luminance” (or “luma”) component, which represents the brightness of the pixel, and “chrominance” (or “chroma”) components, which represent the color of the pixel.
The term “macroblock,” and its inflected forms, is defined as a region of a video frame that is encoded as a unit. In accordance with the illustrative embodiment, a macroblock is an array of 16×16 pixels in the original video frame.
The term “sub-block,” and its inflected forms, is defined as a region of a macroblock that is transformed as a unit. In accordance with the illustrative embodiment, a sub-block is an array of 4×4 pixels.
The term “block,” and its inflected forms, is defined as a region of a video frame of information that is transformed or encoded, or both, as a unit. The term “block” refers to either a macroblock within a video frame or a sub-block within a macroblock.
In this specification, a given block within a frame or macroblock is identified as “block (x,y)”. The “x” index refers to column x and is indexed in ascending order from left to right within the frame or macroblock. The “y” index refers to row y of blocks and is indexed in ascending order from top to bottom within the frame or macroblock. For example, block (x+1, y−2) is situated one block to the right of and two blocks above block (x,y).
The term “deblocking,” and its inflected forms, is defined as filtering one or more regions of pixels in an image frame, so as to ameliorate the square or rectangular distortion (i.e., the “blockiness”) in the image.

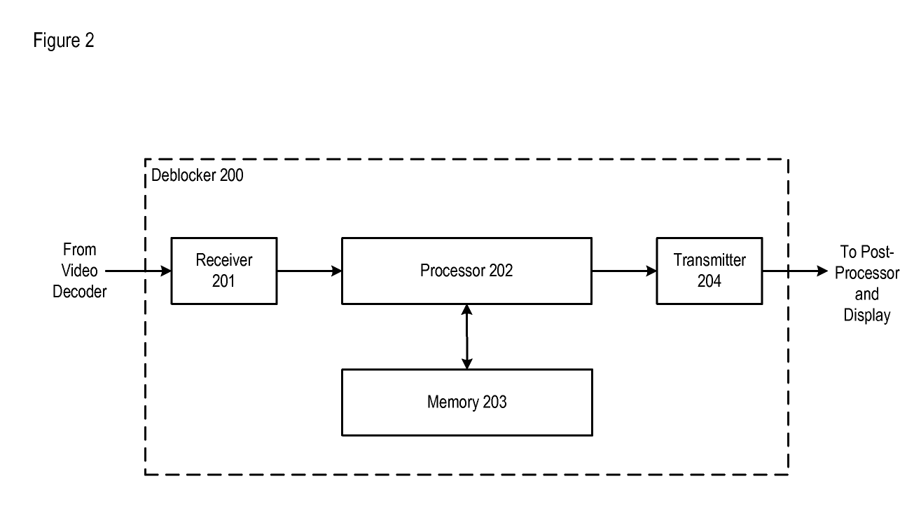

FIG. 2 depicts a block diagram of the salient components of deblocker 200 that is part of a video decoding system, in accordance with the illustrative embodiment. Deblocker 200 comprises: receiver 201, processor 201, memory 203, and transmitter 204, which are interconnected as shown.

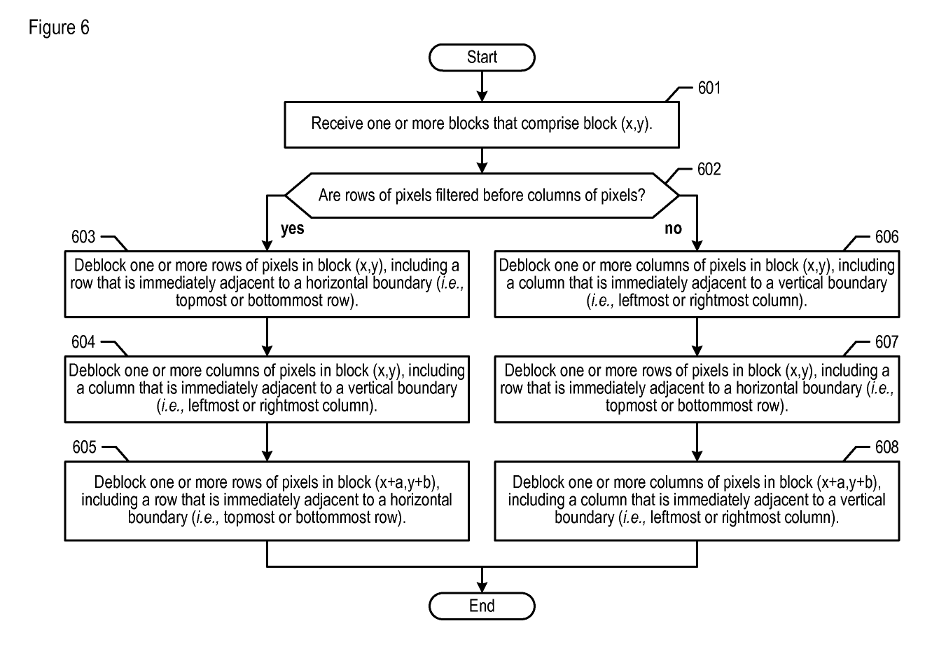

Receiver 201 receives information from the video decoder, as described below and with respect to FIG. 6, and forwards this information to processor 202.

Processor 202 is a general-purpose processor as is well-known in the art that is capable of executing the operating system and user programs in memory 203, and of writing into and removing from memory 203 one or more blocks of video data. The user programs perform the tasks described below and with respect to FIG. 6. Processor 202 is also capable of receiving input from receiver 201 and sending output to transmitter 204 in well-known fashion.

Memory 203 is a non-volatile memory that stores:

i. the operating system and user programs for processor 202, and

ii. one or more blocks of video data,

as described with respect to FIG. 6.

Transmitter 204 receives deblocked output from processor 202 and transmits it to the post-processing and display systems.

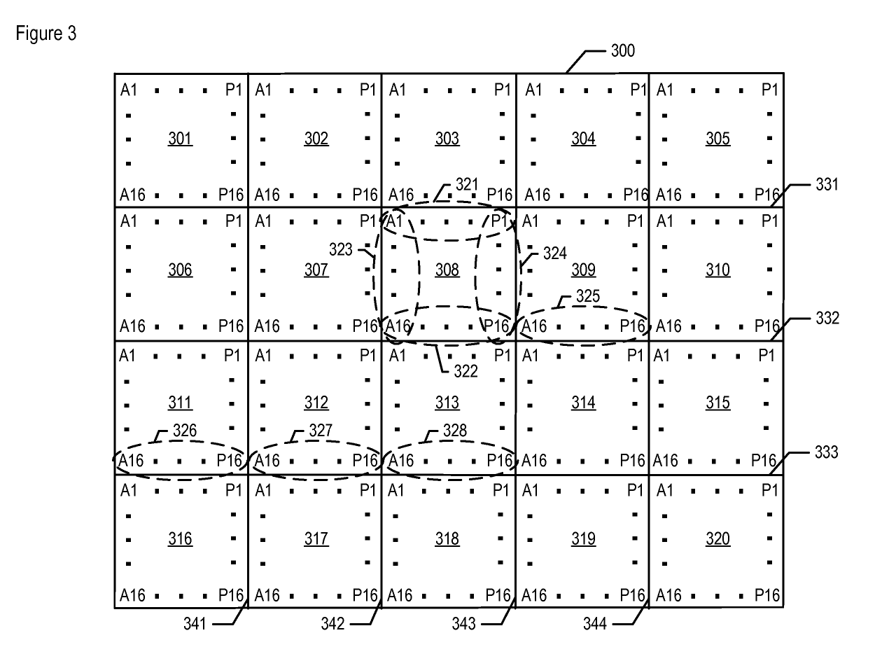

FIG. 3 depicts the format of video frame 300, in accordance with the illustrative embodiment of the present invention, in which some precedence is given to filtering a row of pixels before a column of pixels with respect to deblocking. The filtering that is specified in the Society of Motion Picture and Television Engineers (SMPTE) 421M standard (also known as “VC-1”) is an example of row-before-column filtering. Video frame 300 comprises macroblocks 301 through 320 that have been decoded—and, therefore, are available to deblocker 200—in the order of top row first, followed by each successive row, and left to right within each row. Although video frame 300 comprises twenty macroblocks, it will be clear to those who are skilled in the art how to apply the present invention to a video frame that comprises a different number of macroblocks.

Each macroblock 301 through 320 is a 16×16 array of pixels. It will be clear, however, to those skilled in the art how to apply the present invention to macroblocks that comprise a different size array than 16×16 pixels (e.g., 8×8 pixels, etc.) or to macroblocks of different sizes within a frame (e.g., 4×4-pixel macroblocks co-existing with 16×16-pixel macroblocks, etc.). In each 16×16-pixel macroblock, there are 16 columns of pixels, where the leftmost column consists of pixels A1 through A16 and the rightmost column consists of pixels P1 through P16. Similarly, in each macroblock there are 16 rows of pixels, where the topmost row consists of pixels A1 through P1 and the bottommost row consists of pixels A16 through P16.

As part of the overall deblocking process, one or more rows of pixels near a side (i.e., the top or bottom) within each macroblock are filtered in well-known fashion to produce a smoother visual transition at the horizontal boundaries of the current macroblock. For example, the topmost row of pixels (i.e., row 321) of macroblock 308 is filtered by using adjacent pixels, including the bottommost row of pixels of macroblock 303, which is situated above macroblock 308. Similarly, one or more columns of pixels near a side (i.e., the left-side or right-side) within each macroblock are filtered in well-known fashion to produce a smoother visual transition at the vertical boundaries of the macroblock. For example, the leftmost column of pixels (i.e., column 323) of macroblock 308 is filtered by using adjacent pixels, including the rightmost column of pixels of macroblock 307, which is situated to the left of macroblock 308.

Video frame 300 is deblocked by filtering pixels along horizontal boundaries 331, 332, and 333, as well as by filtering pixels along vertical boundaries 341, 342, 343, and 344. In contrast to some techniques in the prior art, however, frame 300 is not deblocked by filtering all horizontal boundaries first, followed by all vertical boundaries. Instead, frame 300 is deblocked in a manner in which the only requirement in filtering order is that any pixel that belongs to both a filtered row and column of pixels is filtered first as part of the row and then as part of the column. As an example, pixel A1 of macroblock 308 belongs to both row 321 and column 323, in which row 321 is filtered first, followed by column 323. As another example, pixel A16 of macroblock 308 belongs to both row 322 and column 323, in which row 322 is filtered first, followed by column 323.

Subsequently, one or more rows, such as rows 325 through 328, are deblocked. In other words, in accordance with the illustrative embodiment, some rows near a macroblock boundary are deblocked after some columns, as long the row-before-column rule is not violated for a pixel that belongs to both a filtered row and column.

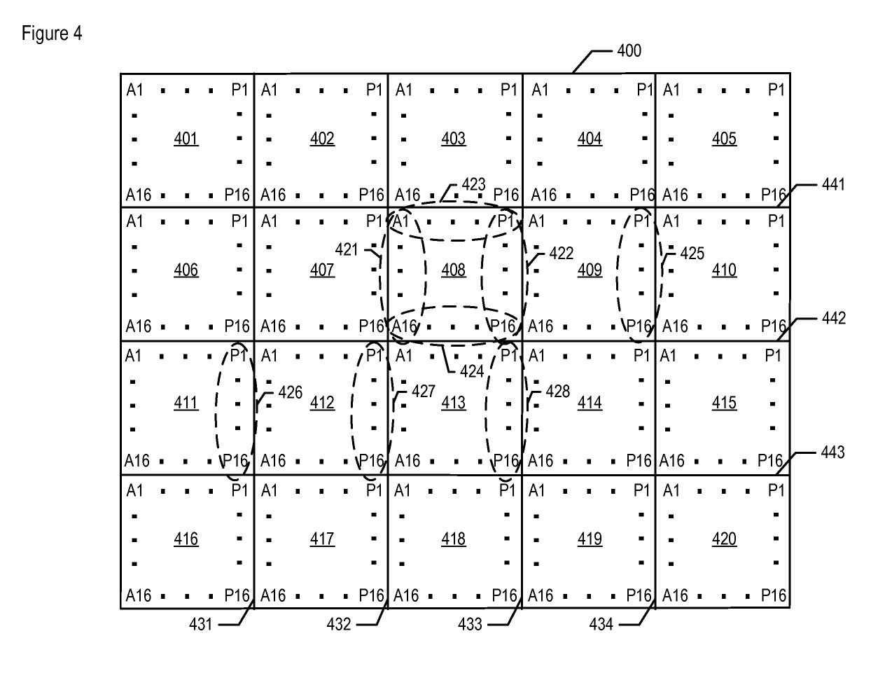

FIG. 4 depicts the format of video frame 400, in accordance with the illustrative embodiment of the present invention, in which some precedence is given to filtering a column of pixels before a row of pixels with respect to deblocking. The filtering that is specified in the ITU Telecommunication Standardization Sector (ITU-T) H.264 standard is an example of column-before-row filtering. Video frame 400 comprises macroblocks 401 through 420 that have been decoded—and, therefore, are available to deblocker 200—in the order of top row first, followed by each successive row, and left to right within each row. Although video frame 400 comprises twenty macroblocks, it will be clear to those who are skilled in the art how to apply the present invention to a video frame that comprises a different number of macroblocks.

Each macroblock 401 through 420 is a 16×16 array of pixels. It will be clear, however, to those skilled in the art how to apply the present invention to macroblocks that comprise a different size array than 16×16 pixels (e.g., 8×8 pixels, etc.) or to macroblocks of different sizes within a frame (e.g., 4×4-pixel macroblocks co-existing with 16×16-pixel macroblocks, etc.). In each 16×16-pixel macroblock, there are 16 columns of pixels, where the leftmost column consists of pixels A1 through A16 and the rightmost column consists of pixels P1 through P16. Similarly, in each macroblock there are 16 rows of pixels, where the topmost row consists of pixels A1 through P1 and the bottommost row consists of pixels A16 through P16.

As part of the overall deblocking process, one or more columns of pixels near a side (i.e., the left-side or right-side) within each macroblock are filtered in well-known fashion to produce a smoother visual transition at the vertical boundaries of the macroblock. For example, the leftmost column of pixels (i.e., column 421) of macroblock 408 is filtered by using adjacent pixels, including the rightmost column of pixels of macroblock 407, which is situated to the left of macroblock 408. Similarly, one or more rows of pixels near a side (i.e., the top or bottom) within each macroblock are filtered in well-known fashion to produce a smoother visual transition at the horizontal boundaries of the current macroblock. For example, the topmost row of pixels (i.e., row 423) of macroblock 408 is filtered by using adjacent pixels, including the bottommost row of pixels of macroblock 403, which is situated above macroblock 408.

Video frame 400 is deblocked by filtering pixels along vertical boundaries 431, 432, 433, and 434, as well as by filtering pixels along horizontal boundaries 441, 442, and 443. In contrast to some techniques in the prior art, however, frame 400 is not deblocked by filtering all vertical boundaries first, followed by all horizontal boundaries. Instead, frame 400 is deblocked in a manner in which the only requirement in filtering order is that any pixel that belongs to both a filtered column and row of pixels is filtered first as part of the column and then as part of the row. As an example, pixel A1 of macroblock 408 belongs to both column 421 and row 423, in which column 421 is filtered first, followed by row 423. As another example, pixel P1 of macroblock 408 belongs to both column 422 and row 423, in which column 422 is filtered first, followed by row 423.

Subsequently, one or more columns, such as columns 425 through 428, are deblocked. In other words, in accordance with the illustrative embodiment, some columns near a macroblock boundary are deblocked after some rows, as long the column-before-row rule is not violated for a pixel that belongs to both a filtered column and row.

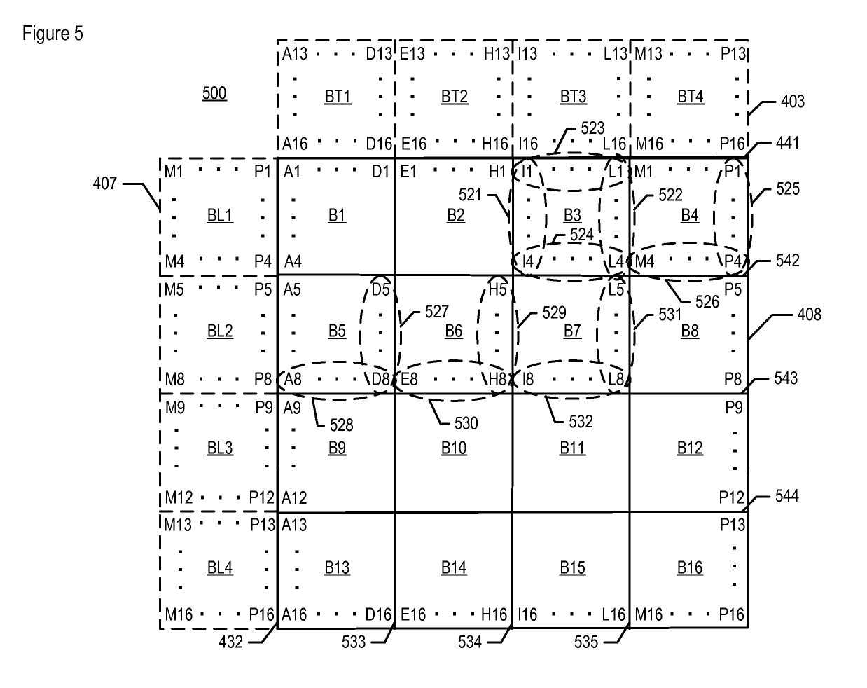

FIG. 5 depicts the format of video frame region 500, in accordance with the illustrative embodiment of the present invention. Frame region 500 comprises the macroblock that is currently being filtered by deblocker 200, macroblock 408. In accordance with the variation of the illustrative embodiment that is described above and with respect to FIG. 4, any pixel that is a member of both a filtered row and column, such as a corner pixel, is subject to the filtering of the column first (i.e., along the vertical boundary), followed by the row (i.e., along the horizontal boundary). Current macroblock 408 comprises a 4×4 array of sub-blocks, which are referred to as sub-blocks B1 through B16. Each sub-block within macroblock 408 comprises 16 pixels in a 4×4-pixel array. Although a sub-block that consists of 4×4 pixels is depicted, in some alternative embodiments, a sub-block of a different size (e.g., 8×8 pixels, etc.) can be used, as those who are skilled in the art will appreciate.

FIG. 5 also depicts the sub-blocks (i.e., BT1 through BT4) from macroblock 403 that are immediately adjacent to the top of macroblock 408 and the sub-blocks (i.e., BL1 through BL4) from macroblock 407 that are immediately adjacent to the left of macroblock 408. One or more rows of pixels near the bottom of each of sub-blocks BT1, BT2, BT3, and BT4 are used to filter one or more rows of pixels near the top of each of sub-blocks B1, B2, B3, and B4, respectively. Similarly, one or columns of pixels near the right side of each of sub-blocks BL1, BL2, BL3, and BL4 are used to filter one or more columns of pixels near the left side of sub-blocks B1, B5, B9, and B13, respectively.

As part of the overall deblocking process, one or more columns of pixels near a side (i.e., the left-side or right-side) within each sub-block are filtered in well-known fashion to produce a smoother visual transition at the vertical boundaries of the sub-block. For example, the leftmost column of pixels (i.e., column 521) of sub-block B3 is filtered by using adjacent pixels, including the rightmost column of pixels of sub-block B2, which is situated to the left of sub-block B3. Similarly, one or more rows of pixels near a side (i.e., the top or bottom) within each sub-block are filtered in well-known fashion to produce a smoother visual transition at the horizontal boundaries of the current sub-block. For example, the topmost row of pixels (i.e., row 523) of sub-block B3 is filtered by using adjacent pixels, including the bottommost row of pixels of sub-block BT3, which is situated above sub-block B3.

Macroblock 408 is deblocked by filtering pixels along vertical boundaries 432, 533, 534, and 535, as well as by filtering pixels along horizontal boundaries 441, 542, 543, and 544. In contrast to some techniques in the prior art, however, macroblock 408 is not deblocked by filtering all vertical boundaries first, followed by all horizontal boundaries. Instead, macroblock 408 is deblocked in a manner in which the only requirement in filtering order is that any pixel that belongs to both a filtered column and row of pixels is filtered first as part of the column and then as part of the row. As an example, pixel I1 of sub-block B3 belongs to both column 521 and row 523, in which column 521 is filtered first, followed by row 523. As another example, pixel L1 of sub-block B3 belongs to both column 522 and row 523, in which column 522 is filtered first, followed by row 523.

Subsequently, one or more columns, such as columns 525, 527, 529, and 531, are deblocked. In other words, in accordance with the illustrative embodiment, some columns in a macroblock are deblocked after some rows, as long the column-before-row rule is not violated for a pixel that belongs to both a filtered column and row.

In some alternative embodiments, as with the row-then-column filtering described above and with respect to FIG. 3, each sub-block is filtered in a row-then-column order. As an example, pixel I1 of sub-block B3 belongs to both column 521 and row 523, in which row 523 is filtered first, followed by column 521. As another example, pixel L1 of sub-block B3 belongs to both column 522 and row 523, in which row 523 is filtered first, followed by column 522. Subsequently, one or more rows, such as rows 526, 528, 530, and 532, are deblocked. In other words, some rows in a macroblock are deblocked after some columns, as long the row-before-column rule is not violated for a pixel that belongs to both a filtered column and row.

In some alternative embodiments, the filtering along macroblock boundaries is performed in a different row/column ordering than for the filtering along sub-block boundaries. For example, the filtering might be performed along all of the horizontal (or vertical) macroblock boundaries first, followed by filtering along all of the vertical (or horizontal) macroblock boundaries, followed by filtering along all sub-block boundaries that is in accordance with the illustrative embodiment.

FIG. 6 depicts a flowchart of the salient tasks associated with deblocking a video frame or macroblock that comprises block (x, y), in accordance with the illustrative embodiment of the present invention. As those who are skilled in the art will appreciate, some of the tasks that appear in FIG. 6 can be executed in a different order than the order depicted.

At task 601, deblocker 200 receives one or more decoded blocks that comprise block (x, y), wherein x and y are integers.

At task 602, deblocker 200 determines if a pixel that is subject to both column and row filtering is to be filtered row first or column first. If the row is to be filtered first (i.e., row-first mode), task execution proceeds to task 603. If the column is to be filtered first (i.e., column-first mode), task execution proceeds to task 606.

At task 603, deblocker 200 deblocks the topmost row of pixels or bottommost row of pixels, or both, of block (x, y) in well-known fashion. In some embodiments, one or more rows that are adjacent to the filtered outermost row (i.e., topmost or bottommost) are also filtered in well-known fashion.

At task 604, deblocker 200 deblocks the leftmost column of pixels or rightmost column of pixels, or both, of block (x, y) in well-known fashion. In some embodiments, one or more columns that are adjacent to the filtered outermost column (i.e., leftmost or rightmost) are also filtered in well-known fashion. In a row-first mode, the deblockings that are described with respect to task 604 are performed after the deblockings that are described with respect to task 603.

At task 605, deblocker 200 deblocks the topmost row of pixels or bottommost row of pixels, or both, of block (x+a, y+b) in well-known fashion, wherein a and b are integers. In some embodiments, at least one of a and b is a positive integer. In some other embodiments, at least one of a and b is a positive integer, and b is not negative. For example, values for the pair (a, b) can be (1, 0), (−2, 1), (−1, 1), (0, 1), and so forth. In some alternative embodiments, one or more rows that are adjacent to the filtered outermost row (i.e., topmost or bottommost) are also filtered in well-known fashion. In a row-first mode, the deblockings that are described with respect to task 605 are performed after the deblockings that are described with respect to task 604, in accordance with the illustrative embodiment of the present invention. Task execution then ends.

At task 606, deblocker 200 deblocks the leftmost column or rightmost column, or both, of block (x, y) in well-known fashion. In some embodiments, one or more adjacent columns to the filtered outermost column (i.e., leftmost or rightmost) are also filtered in well-known fashion.

At task 607, deblocker 200 deblocks the topmost row of pixels or bottommost row of pixels, or both, of block (x, y) in well-known fashion. In some embodiments, one or more rows that are adjacent to the filtered outermost row (i.e., topmost or bottommost) are also filtered in well-known fashion. In a column-first mode, the deblockings that are described with respect to task 607 are performed after the deblockings that are described with respect to task 606.

At task 608, deblocker 200 deblocks the leftmost column of pixels or rightmost column of pixels, or both, of block (x+a, y+b) in well-known fashion, wherein a and b are integers. In some embodiments, at least one of a and b is a positive integer. In some other embodiments, at least one of a and b is a positive integer, and b is not negative. For example, values for the pair (a, b) can be (1, 0), (−2, 1), (−1, 1), (0, 1), and so forth. In some alternative embodiments, one or more columns that are adjacent to the filtered outermost column (i.e., leftmost or rightmost) are also filtered in well-known fashion. In a column-first mode, the deblockings that are described with respect to task 608 are performed after the deblockings that are described with respect to task 607, in accordance with the illustrative embodiment of the present invention. Task execution then ends.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method of deblocking an array of decoded blocks, said method comprising:
deblocking the topmost row of block (x, y);
deblocking the leftmost column of block (x, y) after deblocking the topmost row of block (x, y); and
deblocking the bottommost row of block (x+a, y+b) after deblocking the leftmost column of block (x, y);
wherein at least one of a and b is a positive integer, and wherein x and y are integers.

2. The method of claim 1 wherein a=1 and b=0.

3. The method of claim 1 wherein a=−2 and b=1.

4. The method of claim 1 wherein a=−1 and b=1.

5. The method of claim 1 wherein a=0 and b=1.

6. A method of deblocking an array of decoded blocks, said method comprising:
deblocking the bottommost row of block (x, y);
deblocking the leftmost column of block (x, y) after deblocking the bottommost row of block (x, y); and
deblocking the bottommost row of block (x+a, y+b) after deblocking the leftmost column of block (x, y);
wherein at least one of a and b is a positive integer, and wherein x and y are integers.

7. The method of claim 6 wherein a=1 and b=0.

8. The method of claim 6 wherein a=−2 and b=1.

9. The method of claim 6 wherein a=−1 and b=1.

10. The method of claim 6 wherein a=0 and b=1.

11. A method of deblocking an array of decoded blocks, said method comprising:
deblocking the leftmost column of block (x, y);
deblocking the topmost row of block (x, y) after deblocking the leftmost column of block (x, y); and
deblocking the rightmost column of block (x+a, y+b) after deblocking the topmost row of block (x, y);
wherein at least one of a and b is a positive integer, and wherein x and y are integers.

12. The method of claim 11 wherein a=1 and b=0.

13. The method of claim 11 wherein a=−2 and b=1.

14. The method of claim 11 wherein a=−1 and b=1.

15. The method of claim 11 wherein a=0 and b=1.

16. A method of deblocking an array of decoded blocks, said method comprising:
deblocking the rightmost column of block (x, y);
deblocking the topmost row of block (x, y) after deblocking the rightmost column of block (x, y); and
deblocking the rightmost column of block (x+a, y+b) after deblocking the topmost row of block (x, y);
wherein at least one of a and b is a positive integer, and wherein x and y are integers.

17. The method of claim 16 wherein a=1 and b=0.

18. The method of claim 16 wherein a=−2 and b=1.

19. The method of claim 16 wherein a=−1 and b=1.

20. The method of claim 16 wherein a=0 and b=1.
